(19) United States
(12) Patent Application Publication
(10) Pub. No.: US 2014/0321851 A1
(43) Pub. Date: Oct. 30, 2014

(54) TRANSMISSION DEVICE AND SYNCHRONIZATION CONTROL METHOD

(71) Applicant: FUJITSU LIMITED, Kawasaki-shi (JP)

(72) Inventors: Toshiharu HIROSE, Fukuoka (JP); Kenichi Ohyama, Fukuoka (JP); Akira Hashimoto, Fukuoka (JP); Haruhisa Fukano, Munakata (JP)

(73) Assignee: FUJITSU LIMITED, Kawasaki-shi (JP)

(21) Appl. No.: 14/222,884

(22) Filed: Mar. 24, 2014

(30) Foreign Application Priority Data
Apr. 30, 2013 (JP) 2013-095978

(51) Int. Cl. H04B 10/27

(52) U.S. Cl. CPC H04B 10/27
USPC 398/50

(57) ABSTRACT

A transmission device includes: a detector to detect a head pattern indicating a head of data for each of ports that receives the data; a write controller to write the data to a memory provided for each of the ports, based on a detection timing of the head pattern detected by the detector; a determination unit to determine, among ports for each of which the head pattern has been detected by the detector, a specific port for which a total delay amount is minimum, the total delay amount being a total sum of delay amounts from the head pattern related to the specific port to each of the head patterns related to ports other than the specific port; and a read controller to read the data from the memory, based on the detection timing of the head pattern related to the specific port determined by the determination unit.

### CROSS-REFERENCE TO RELATED APPLICATION

This application is based upon and claims the benefit of priority of the prior Japanese Patent Application No. 2013-095978, filed on Apr. 30, 2013, the entire contents of which are incorporated herein by reference.

### FIELD

The embodiments discussed herein are related to a transmission device and a synchronization control method.

### BACKGROUND

Recently, communication schemes in accordance with international standards, such as synchronous optical network/synchronous digital hierarchy (SONET/SDH), have attracted much attention as high-speed digital-communication schemes using optical fibers. In such communication schemes, data is sent through an optical fiber from a source terminal, and the data is transmitted to a destination terminal while being subjected to cross-connect processing by a transmission device that connects a plurality of optical fibers.

In cross-connect processing in a transmission device, the transmission path of data is typically changed by using a switch. At this point, in the transmission device, the heads of data are aligned using memories, and then synchronous processing for causing the data with aligned heads to be input from the memories to the switch is performed. That is, in synchronous processing, the transmission device detects a head pattern indicating the head of data for each of ports that receives input of the data, and writes the data to a memory provided for each port at the detection timing of the detected head pattern. Then, at an arbitrary timing at which pulses are generated by using a pulse generator or the like, the transmission device concurrently reads data from the memories and outputs the read data to a switch. Thus, the heads of data input to the switch are aligned, and the transmission paths of the data with aligned heads are changed by the switch.

Japanese Laid-open Patent Publication No. 4-37336 and Japanese Laid-open Patent Publication No. 2000-269946 disclose examples of the related art.

### SUMMARY

According to an aspect of the invention, a transmission device includes: a detector configured to detect a head pattern indicating a head of data for each of ports that receives the data; a write controller configured to write the data to a memory provided for each of the ports, based on a detection timing of the head pattern detected by the detector; a determination unit configured to determine, among ports for each of which the head pattern has been detected by the detector, a specific port for which a total delay amount is minimum, the total delay amount being a total sum of delay amounts from the head pattern related to the specific port to each of the head patterns related to ports other than the specific port; and a read controller configured to read the data from the memory, based on the detection timing of the head pattern related to the specific port determined by the determination unit.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of a configuration of a transmission system including transmission devices according to this embodiment;

FIG. 2 is a block diagram illustrating a configuration of the transmission device illustrated in FIG. 1;

FIG. 3 is an explanatory diagram for explaining a synchronization control method performed by a transmission device of a first embodiment;

FIG. 4 is a block diagram illustrating a detailed configuration of a cross-connect unit in first embodiment;

FIG. 5 is a block diagram illustrating a configuration of the specific port determination unit in the first embodiment:

FIG. 6A is an explanatory diagram for explaining a specific example of synchronization control processing performed by the transmission device of the first embodiment;

FIG. 6B is an explanatory diagram for explaining the specific example of synchronization control processing performed by the transmission device of the first embodiment;

FIG. 6C is an explanatory diagram for explaining the specific example of synchronization control processing performed by the transmission device of the first embodiment;

FIG. 6D is an explanatory diagram for explaining the specific example of synchronization control processing performed by the transmission device of the first embodiment;

FIG. 7 is a flowchart illustrating a processing procedure of the synchronization control processing performed by the transmission device of the first embodiment;

FIG. 8 is a block diagram illustrating a detailed configuration of a cross-connect unit in a second embodiment;

FIG. 9 is a block diagram illustrating a configuration of a specific port determination unit in the second embodiment;

FIG. 10 is an explanatory diagram for explaining a specific example of synchronization control processing performed by a transmission device of the second embodiment; and

FIG. 11 is a flowchart illustrating a processing procedure of the synchronization control processing performed by the transmission device of the second embodiment.

### DESCRIPTION OF EMBODIMENTS

In conventional transmission devices conforming to a communication scheme such as SONET/SDH, there is a problem that the delay of data increases when the data is concurrently read from memories.

Specifically, in conventional transmission devices, since the timing at which data is read from memories is an arbitrary timing, the delay time from a time point at which data is written to the memories to a time point at which the data is read from the memories is sometimes long. For this reason, in conventional transmission devices, there is a possibility that delay of data could increase as the delay time of data becomes long.

In a communication scheme using optical fibers, a plurality of transmission devices are typically installed between a terminal from which data is sent and a terminal for which transmission of the data is destined. Therefore, the transmission delay associated with reading of data from memories is accumulated when cross-connect processing is performed by each transmission device. As a result, there is a possibility that the delay of data could further increase.

Embodiments of a transmission device and a synchronization control method capable of reducing the delay of data will be described in detail with reference to the drawings. Note that the disclosed technique is not limited by the embodiments.

### First Embodiment

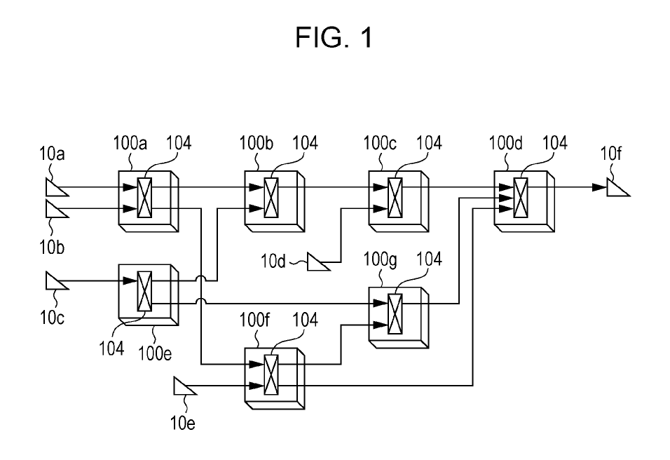

FIG. 1 is a diagram illustrating an example of a configuration of a transmission system including transmission devices according to this embodiment. The transmission system illustrated in FIG. 1 includes terminals 10a to 10f and transmission devices 100a to 100g. The transmission devices 100a to 100g are connected in a mesh fashion. Note that, in cases where the transmission devices 100a to 100g are not distinguished from one another, the transmission devices 100a to 100g will be referred to as a “transmission devices 100” below.

The terminals 10a and 10b connect to the transmission device 100a, the terminal 10c connects to the transmission device 100e, the terminal 10d connects to the transmission device 100c, the terminal 10e connects to the transmission device 100f, and the terminal 10f connects to the transmission device 100d. These terminals 10a to 10f send and receive data through the transmission devices 100a to 100g. For example, the terminal 10a connecting to the transmission device 100a sends and receives data through the transmission devices 100a, 100b, 100c and 100d to and from the terminal 10f connecting to the transmission device 100d.

Each transmission device 100 includes a cross-connect unit 104. The cross-connect unit 104 performs cross-connect processing on data relayed among the transmission devices 100. In particular, the cross-connect unit 104 changes the transmission path of data by using a switch. At this point, in the transmission device 100, the heads of data are aligned using memories, and then synchronous processing for causing the data with the aligned heads to be input from the memories to the switch is performed. The delay associated with this synchronous processing becomes one factor of delay of data in the transmission device.

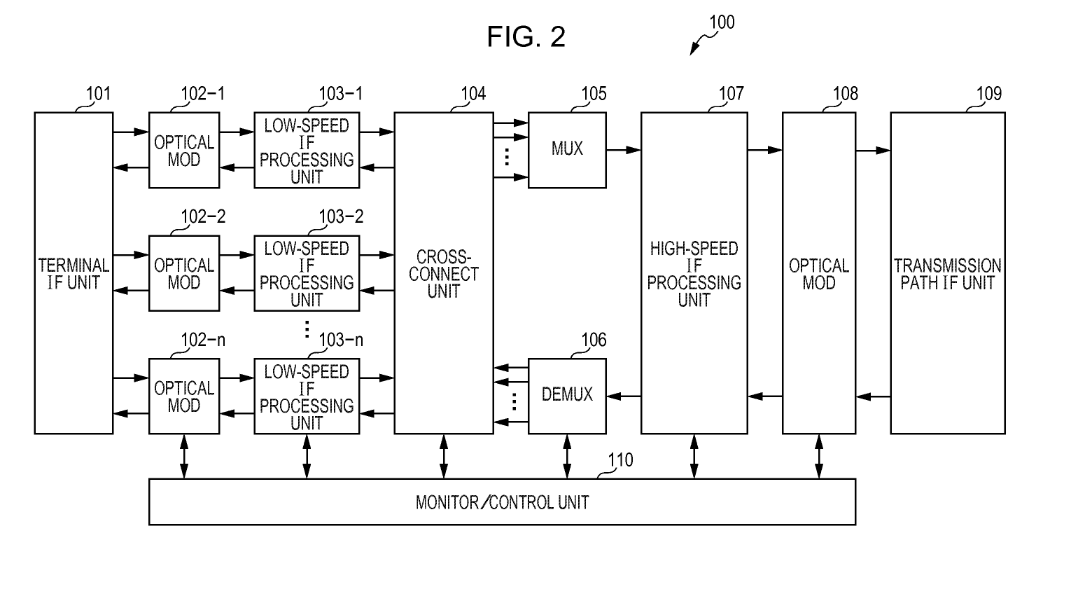

FIG. 2 is a block diagram illustrating a configuration of the transmission device illustrated in FIG. 1. As illustrated in FIG. 2, the transmission device 100 includes a terminal interface (IF) unit 101, optical modules (MOD) 102-1 to 102-n, low-speed IF processing units 103-1 to 103-n, a cross-connect unit 104, and a multiplexer (MUX) 105. The transmission device 100 also includes a demultiplexer (DEMUX) 106, a high-speed IF processing unit 107, an optical module 108, a transmission path IF unit 109, and a monitor/control unit 110.

The terminal IF unit 101 connects to the terminals 10a to 10f and so forth over transmission paths of optical fibers and the like, and outputs data input from the terminals 10a to 10f to the optical modules 102-1 to 102-n. The terminal IF unit 101 also outputs data input from the optical modules 102-1 to 102-n to the terminals 10a to 10f and so forth over transmission paths of optical fibers and the like.

The optical modules 102-1 to 102-n perform photoelectric conversion of data.

The low-speed IF processing units 103-1 to 103-n perform receiving processing, such as alarm detection, on data from the terminals 10a to 10f and outputs the data, on which the receiving processing has been performed, to the cross connect unit 104. The low-speed IF processing units 103-1 to 103-n also perform predetermined sending processing on data from the cross-connect unit 104 and outputs the data, on which the sending processing has been performed, to the optical modules 102-1 to 102-n.

The cross-connect unit 104 changes the transmission path of data from the low-speed IF processing units 103-1 to 103-n and from the demultiplexer 106, and outputs the data, the transmission path of which has been changed, to the low-speed IF processing units 103-1 to 103-n or the multiplexer 105. Specifically, the cross-connect unit 104 changes the transmission path of data by using a switch. At this point, in the transmission device 100, the heads of data are aligned using memories, and then synchronous processing for causing the data with the aligned heads to be input from the memories to the switch is performed. The detailed configuration of the cross-connect unit 104 will be described below.

The multiplexer 105 multiplexes data from the cross-connect unit 104 and outputs the multiplexed data to the high-speed IF processing unit 107. The demultiplexer 106 separates data from the high-speed IF processing unit 107 and outputs the separated data to the cross-connect unit 104.

The high-speed IF processing unit 107 performs receiving processing, such as alarm detection, on data from other transmission devices 100 and outputs the data, on which the receiving processing has been performed, to the demultiplexer 106. The high-speed IF processing unit 107 also performs predetermined sending processing on data from the multiplexer 105 and outputs the data, on which the sending processing has been performed, to the optical module 108.

The optical module 108 performs photoelectric conversion of data.

The transmission path IF unit 109 connects to other transmission devices 100 over transmission paths of optical fibers and the like, and outputs data input from other transmission devices 100 to the optical module 108. The transmission path IF unit 109 also outputs data input from the optical module 108 to other transmission devices 100.

The monitor/control unit 110 collectively controls the transmission device 100.

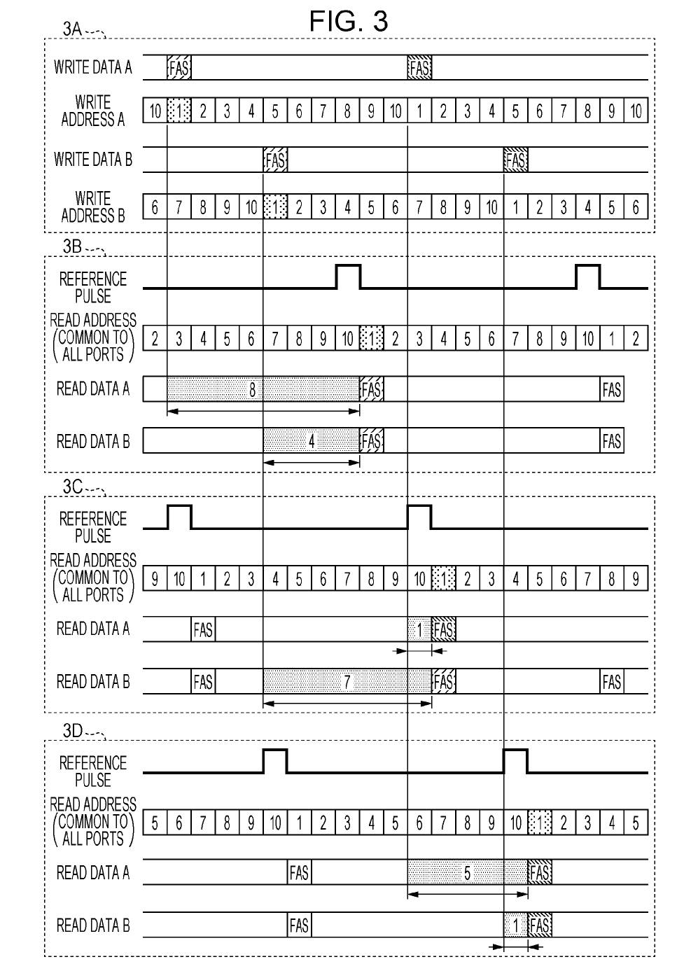

Next, a synchronization control method performed by the transmission device 100 of this embodiment is described. FIG. 3 is an explanatory diagram for explaining a synchronization control method performed by a transmission device of the first embodiment. With reference to FIG. 3, the case where the transmission device 100 has two ports a and b as ports that receive input of data, and the data received from the ports a and b is written as write data A and B to memories, respectively, is described.

As illustrated at reference numeral 3A of FIG. 3, the transmission device 100 detects frame alignment signals (FASs), which are head patterns indicating the heads of the write data A and B input from the ports a and b. Then, the transmission device 100 generates an address that increases with the period of time elapsed from a detection timing of the detected FAS, for each port. For example, a write address A is generated as an address that increases with the period of time elapsed from a timing at which an FAS of the write data A input from the port a is detected. For example, also, a write address B is generated as an address that increases with the period of time elapsed from a timing at which an FAS of the write data B input from the port b is detected. Then, the transmission device 100 writes the write data A and B to memories provided for the respective ports.

Here, the case where the transmission device 100 reads data from memories at an arbitrary timing of generating pulses by using a pulse generator is assumed as a comparative example. In this case, as illustrated at reference numeral 3B of FIG. 3, the transmission device 100 generates a read address in accordance with a reference pulse generated at an arbitrary timing. Then, the transmission device 100 reads read data A and B from memories provided for the ports a and b, respectively, using the generated read addresses. In this case, the delay amount from writing of data, as the write data A, to a memory provided for the port a to reading of the data, as the read data A, from the memory is “8”. The delay amount from writing of data, as the data B, to a memory provided for the port b to reading of the data, as the read data B, from the memory is “4”. Accordingly, the total delay amount is “12” (=8+4).

In contrast, the transmission device 100 of this embodiment determines a specific port for which a total delay amount is minimum, among ports for which the head patterns have been detected. The total delay amount is a total sum of delay amounts from the head pattern related to the specific port to each of the head patterns related to ports other than the specific port. Then, the transmission device 100 of this embodiment reads data from the memory at a detection timing of the head pattern related to the specific port for which it has been determined that the total delay amount is minimum.

Specifically, as illustrated at reference numeral 3C of FIG. 3, the transmission device 100 identifies the port a as a specific port from the ports a and b for which FASs have been detected, and calculates a total sum “8” (=1+7) of delay amounts from the FAS related to the port a to the FAS related to the port b. As illustrated at reference numeral 3D of FIG. 3, the transmission device 100 also identifies the port b as a specific port from the ports a and b for which FASs have been detected, and calculates a total sum “6” (=5+1) of delay amounts from the FAS related to the port a to the FAS related to the port b. Then, the transmission device 100 determines the port b for which the total delay amount is minimum, as the target specific port. Then, the transmission device 100 reads the read data A and B from the memories at the detection timing of an FAS related to the specific port for which it has been determined that the total delay amount is minimum.

In this way, the transmission device 100 of this embodiment reads data from memories at the detection timing of an FAS related to the specific port for which it has been determined that the total delay amount is minimum, instead of reading data from memories at an arbitrary timing as in the comparative example. For this reason, compared with the comparative example, the transmission device 100 of this embodiment enables the delay time from a time point at which data is written to memories to a time point at which the data is read from the memories to be reduced. As a result, with the transmission device 100 of this embodiment, the delay of the data in a transmission device may be reduced.

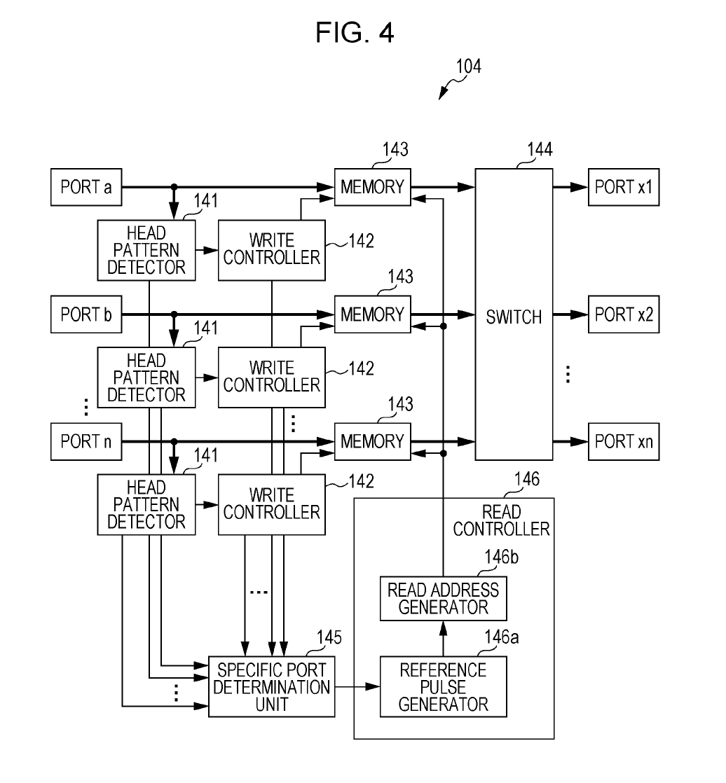

Next, the detailed configuration of the cross-connect unit 104 illustrated in FIG. 2 is described. FIG. 4 is a block diagram illustrating the detailed configuration of the cross-connect unit in the first embodiment. As illustrated in FIG. 4, the cross-connect unit 104 includes a plurality of head pattern detectors 141, a plurality of write controllers 142, a plurality of memories 143, a switch 144, a specific port determination unit 145, and a read controller 146.

Each head pattern detector 141 detects an FAS, which is a head pattern indicating the head of data, for a port that receives input of the data. Each head pattern detector 141 outputs the detected FAS as a head pattern signal to the write controller 142 and the specific port determination unit 145.

For example, the head pattern detectors 141 detect FASs indicating the heads of the data A, B, . . . , N input from the ports a, b, . . . , n, respectively. Then, the head pattern detectors 141 output the detected FASs as the head pattern signals A, B, . . . , N to the write controllers 142 and the specific port determination unit 145.

Each write controller 142 writes data in the memory 143 at the detection timing of an FAS detected by the head pattern detector 141. In particular, the write controllers 142 generate addresses that increase with the periods of time elapsed from the detection timings of FASs detected by the head pattern detector 141, for the respective ports, and write data in the memories 143 using the generated addresses.

For example, the write controllers 142 receive head pattern signals A, B, . . . , N of the write data A, B, . . . , N input from the ports a, b, . . . , n, from the head pattern detectors 141. Then, the write controllers 142 generate write addresses A, B, . . . , N based on the head pattern signals A, B, . . . , N, as addresses that increase with the passages of time from FASs of the write data A, B, . . . , N. Then, the write controllers 142 output write instructions to write data using the generated write addresses A, B, . . . , N, to the memories 143.

When receiving the write instruction from the write controller 142, each memory 143 writes data input from a port to that memory 143. When receiving read instructions from the read controller 146 described below, the memories 143 concurrently read data from themselves, and output the read data to the switch 144.

The switch 144 changes the transmission path of data. In particular, the switch 144 selects predetermined data from data input from each memory 143, and outputs the selected data from any of a plurality of ports x.

The specific port determination unit 145 specifies a specific port for which a total delay amount is minimum, among ports for which head patterns have been detected by the head pattern detectors 141. The total delay amount is a total sum of delay amounts from a head pattern related to the specific port to each of head patterns related to ports other than the specific port. In particular, the specific port determination unit 145 acquires addresses from all the write controllers 142, calculates a total value of the addresses related to all the ports at the detection timing of an FAS, as the total delay amount for each of the ports, and determines the port for which the calculated total delay amount is minimum as the specific port.

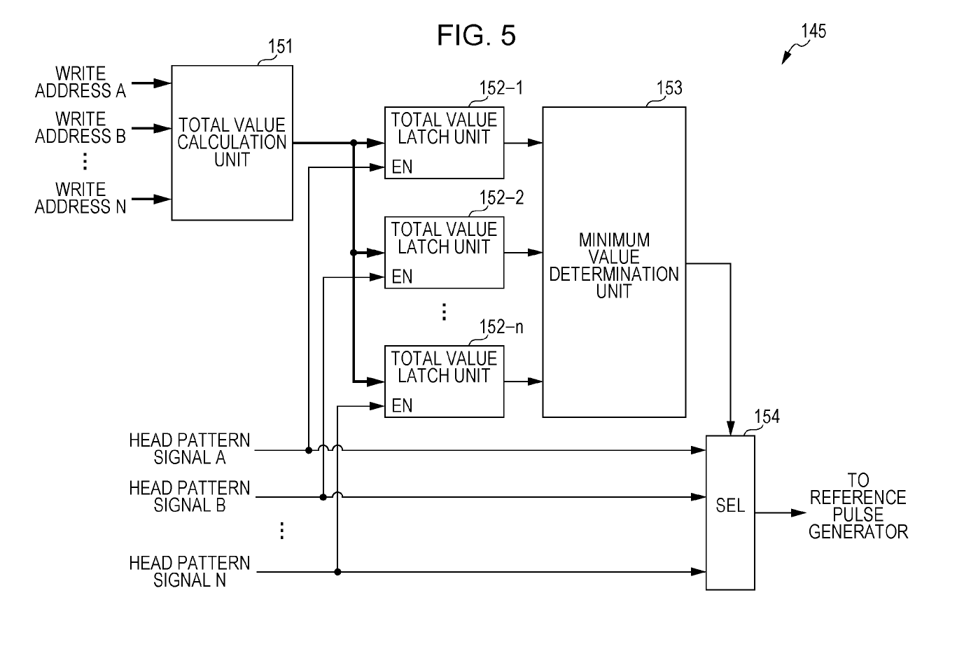

More particularly, as illustrated in FIG. 5, the specific port determination unit 145 includes a total value calculation unit 151, total value latch units 152-1 to 152-n, a minimum value determination unit 153, and a selector (SEL) 154. FIG. 5 is a block diagram illustrating a configuration of a specific port determination unit in the first embodiment.

The total value calculation unit 151 acquires addresses (write addresses A, B, . . . , N) from the write controllers 142, and calculates the total values of the acquired addresses. The total value calculation unit 151 outputs the total values of the calculated addresses to the total value latch units 152-1 to 152-n.

The total value latch units 152-1 to 152-n receive the total values of addresses from the total value calculation unit 151. When receiving the head pattern signals A, B, . . . , N from the head pattern detectors 141, the total value latch units 152-1 to 152-n become enabled, latch the total values of addresses, and outputs the latched total values of addresses to the minimum determination unit 153. In other words, each of the total value latch units 152-1 to 152-n selects one specific port from ports for which FASs have been detected, calculates a total value of the write address related to the selected one specific port and write addresses related to other ports, and outputs the calculated total value of addresses.

The minimum determination unit 153 receives the total values of addresses from the total value latch units 152-1 to 152-n. The minimum determination unit 153 determines a port related to a head pattern signal for which the total value of addresses is minimum, as a specific port. The minimum determination unit 153 outputs information on the specific port for which it has been determined that the total value of addresses is minimum, to the selector 154.

The selector 154 receives the head pattern signals A, B, . . . , N from the head pattern detectors 141. The selector 154 receives information on the specific port for which it has been determined that the total value of addresses is minimum, from the minimum determination unit 153. Then, the selector 154 selects a head pattern signal related to the specific port, for which it has been determined that the total value of addresses is minimum, from the head pattern signals A, B, . . . , N, and outputs the selected head pattern signal to a reference pulse generator 146a of the read controller 146 described below.

Additionally, if the FASs detected by the head pattern detector 141 are not aligned among ports after the specific port for which the total delay amount is minimum is determined, the specific port determination unit 145 redetermines a specific port for which the total delay amount is minimum.

Note that the opportunity for redetermining a specific port for which the total delay amount is minimum is not limited to the fact that FASs are not aligned. For example, if the number of ports that receive input of data is changed after the specific port for which the total delay amount is minimum is determined, the specific port determination unit 145 may redetermine a specific port for which the total delay amount is minimum.

The description is returned to FIG. 4. The read controller 146 reads data from all the memories 143 at a timing of detecting an FAS related to the specific port for which it is determined by the specific port determination unit 145 that the total delay amount is minimum. Specifically, the read controller 146 includes the reference pulse generator 146a and the read address generator 146b.

The reference pulse generator 146a receives a head pattern signal related to the specific port for which it has been determined that the total value of addresses is minimum, from the selector 154 of the specific port determination unit 145. The reference pulse generator 146a generates a reference pulse at a timing of detecting an FAS contained in the head pattern signal, and outputs the generated reference pulse to the read address generator 146b.

The read address generator 146b generates a read address in accordance with the reference pulse generated by the reference pulse generator 146a, and outputs an instruction to read data using the generated read address, to the memory 143.

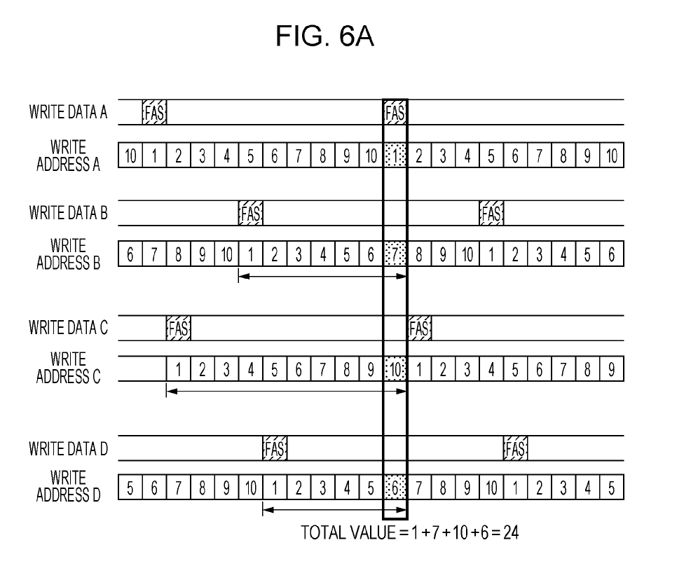

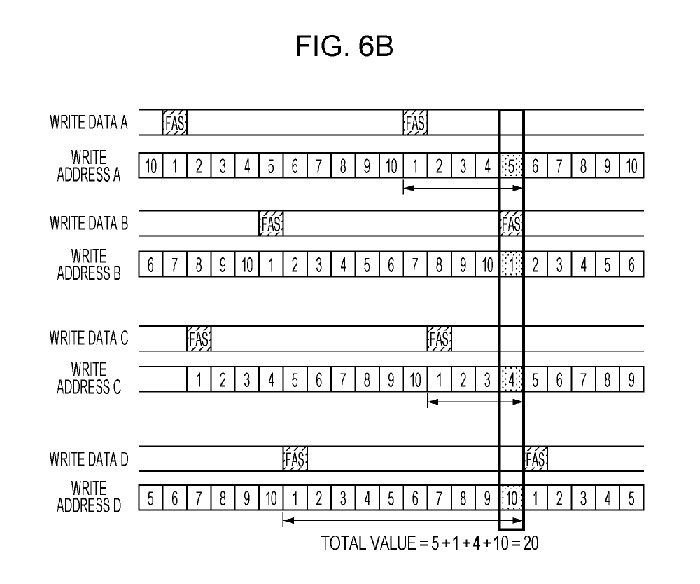

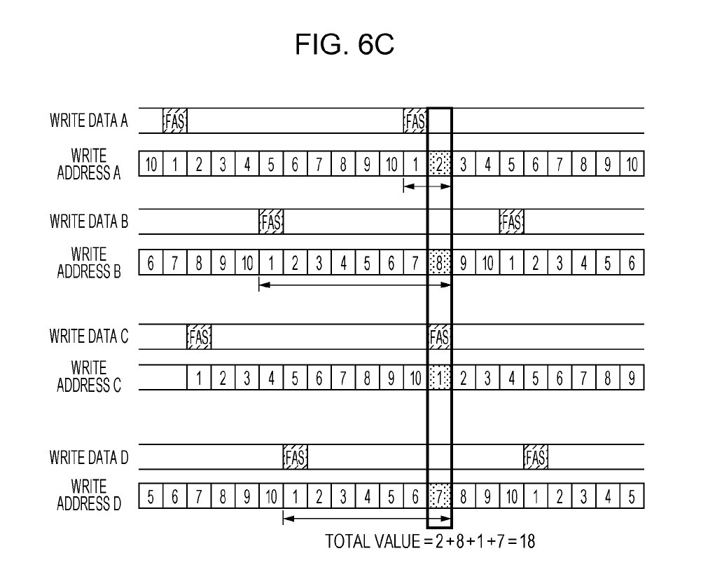

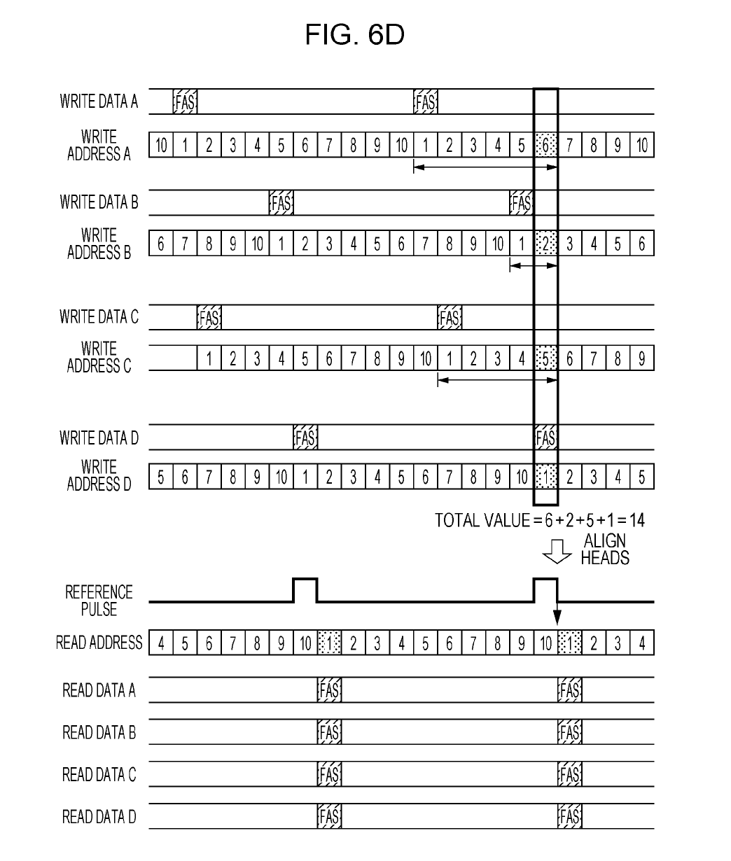

Next, a specific example of synchronization control processing performed by the transmission device 100 of this embodiment is described. FIG. 6A to FIG. 6D are explanatory diagrams for explaining a specific example of synchronization control processing performed by the transmission device of the first embodiment. With reference to FIG. 6A to FIG. 6D, an example where the transmission device 100 includes four ports a, b, c, and d, which are ports that receive input of data, and writes the received data from the ports a, b, c, and d, as write data A, B, C, and D to memories, respectively, is now discussed.

As illustrated in FIG. 6A, the head pattern detectors 141 of the cross-connect unit 104 detect FASs indicating the heads of the write data A, B, C, and D input from the ports a, b, c, and d.

Subsequently, the write controllers 142 generate write addresses A, B, C, and D as addresses that increase with the periods of time elapsed from detection timings of the detected FASs, for the respective ports. Then, the write controllers 142 write the write data A, B, C, and D to the memories 143 provided for the respective ports, using the generated write addresses A, B, C, and D.

Subsequently, the specific port determination unit 145 acquires the write addresses A, B, C, and D from the write controllers 142. Then, as illustrated in FIG. 6A, the specific port determination unit 145 selects the port a from the ports a, b, c, and d for which FASs have been detected, and calculates a total value “24” of the write address A related to the selected port a and the write addresses B, C, and D related to other ports b, c, and d.

As illustrated in FIG. 6B, the specific port determination unit 145 selects the port b from the ports a, b, c, and d for which FASs have been detected, and calculates a total value “20” of the write address B related to the selected port b and the write addresses A, C, and D related to other ports a, c, and d.

As illustrated in FIG. 6C, the specific port determination unit 145 selects the port c from the ports a, b, c, and d for which FASs have been detected, and calculates a total value “18” of the write address C related to the selected port c and the write addresses A, B, and D related to other ports a, b, and d.

As illustrated in an upper part of FIG. 6D, the specific port determination unit 145 selects the port d from the ports a, b, c, and d for which FASs have been detected, and calculates a total value “14” of the write address D related to the selected port d and the write addresses A, B, and C related to other ports a, b, and c.

Subsequently, having selected all the ports, the specific port determination unit 145 determines the port d for which the total value of addresses, that is, the total delay amount is minimum among those of all the ports, as a specific port. Then, the specific port determination unit 145 outputs the head pattern signal D related to the port d, which is the specific port for which it has been determined that the total delay amount is minimum, to the reference pulse generator 146a of the read controller 146.

Subsequently, as illustrated in a lower part of FIG. 6D, the read controller 146 generates a reference pulse in accordance with the detection timing of an FAS contained in the head pattern signal D related to the port d, which is the specific port for which it has been determined that the total delay amount is minimum.

Subsequently, the read controller 146 generates a read address in accordance with the reference pulse, and concurrently reads read data A, B, C, and D from the memories 143 using the generated read address.

In this way, the transmission device 100 of this embodiment acquires write addresses, calculates the total values of addresses related to all the ports at the detection timings of FASs, as total delay amounts, and determines a port for which the calculated total delay amount is minimum, as a specific port. Then, the transmission device 100 of this embodiment reads data from each memory 143 at the detection timing of an FAS related to the specific port for which it has been determined that the total value of addresses is minimum. This enables the transmission device 100 to calculate the total value of existing write addresses as the total delay amount among the ports, and thus to quickly calculate the total delay amount. As a result, with the transmission device 100 of this embodiment, the delay of data in a transmission device may be efficiently reduced.

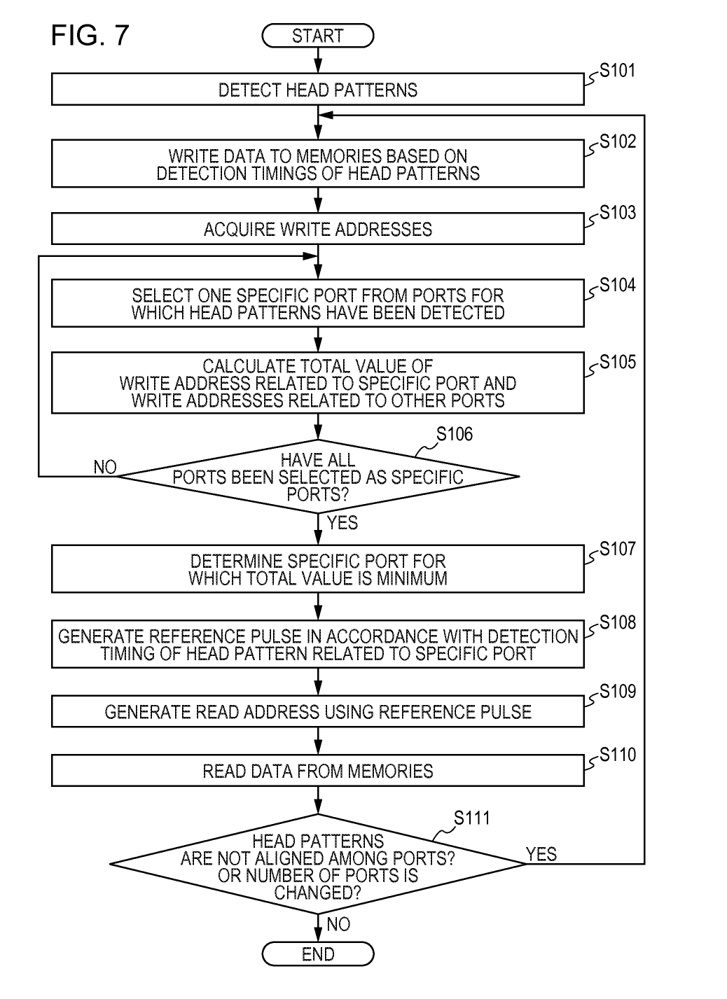

Next, the synchronization control processing performed by the transmission device 100 of this embodiment is described. FIG. 7 is a flowchart illustrating a processing procedure of the synchronization control processing performed by the transmission device of the first embodiment.

As illustrated in FIG. 7, the head pattern detectors 141 of the cross-connect unit 104 detect head patterns (FASs) indicating the heads of write data input from the ports (operation S101).

Subsequently, the write controllers 142 write data to the memories 143 at detection timings of FASs (operation S102). In particular, the write controllers 142 generate write addresses that increase with the periods of time elapsed from the detection timings of FASs detected by the head pattern detectors 141, for the respective ports, and write the generated write addresses to the memories 143 using the generated write addresses.

Subsequently, the specific port determination unit 145 acquires write addresses from the write controllers 142 (operation S103), and selects one specific port from the ports for which FASs have been detected (operation S104). The specific port determination unit 145 calculates the total value of the write address related to the selected specific port and the write addresses related to the other ports (operation S105).

Subsequently, the specific port determination unit 145 determines whether all the ports have been selected as specific ports (operation S106). If there is a port that has not been selected (negative in operation S106), the process returns to operation S104.

If all the ports have been selected as specific ports (affirmative in S106), the specification port determination unit 145 determines a specific port for which the total value of addresses is minimum (operation S107). Here, the total value of addresses corresponds to a total delay amount, which is the total sum of delay amounts from an FAS related to the specific port to each of FASs related to ports other than the specific port.

Subsequently, the read controller 146 generates a reference pulse in accordance with the detection timing of the FAS related to the specific port for which it has been determined by the specific port determination unit 145 that the total delay amount is minimum (operation S108).

Subsequently, the read controller 146 generates a read address in accordance with the reference pulse (operation S109), and reads data from each memory 143 using the generated read address (operation S110). The data read from each memory 143 is input to the switch 144, and the switch 144 changes the transmission path of the data.

Thereafter, if the FASs detected by the head pattern detectors 141 are not aligned among ports, or if the number of ports that receive input of data is changed (affirmative in operation S111), the specific port determination unit 145 returns the process to operation S102. That is, if the FASs detected by the head pattern detectors 141 are not aligned among ports, or if the number of ports that receive input of data is changed, the specific port determination unit 145 redetermines a specific port for which the total delay amount is minimum.

If the FASs detected by the head pattern detectors 141 are aligned among ports, or if the number of ports that receive input of data is not changed (negative in operation S111), the specification port determination unit 145 completes the process.

As described above, the transmission device 100 of this embodiment acquires write addresses, calculates the total values of addresses related to all the ports at the detection timings of FASs, as total delay amounts, and determines a port for which the calculated total delay amount is minimum, as a specific port. Then, the transmission device 100 of this embodiment reads data from each memory 143 at the detection timing of an FAS related to the specific port for which it has been determined that the total value of addresses is minimum. This enables the transmission device 100 to calculate the total value of existing write addresses as the total delay amount among the ports, and thus to quickly calculate the total delay amount. As a result, with the transmission device 100 of this embodiment, the delay of data in a transmission device may be efficiently reduced.

Additionally, after determining the specific port for which the total delay amount is minimum, the transmission device 100 of this embodiment redetermines a specific port for which the total delay amount is minimum if the FASs are not aligned among ports. As a result, with the transmission device 100 of this embodiment, the delay of data in a transmission device may be reduced each time the FASs become not aligned among ports.

Additionally, the transmission device 100 of this embodiment redetermines a specific port for which the total delay amount is minimum if the number of ports is changed. As a result, with the transmission device 100 of this embodiment, the delay of data in a transmission device may be reduced if the number of ports is increased or decreased.

### Second Embodiment

A second embodiment differs from the first embodiment in that a head position indicating the temporal position of a timing at which an FAS is detected, relative to a predetermined reference point of time, is measured for each port, and that the total sum of differences among the measured head positions is calculated as the total delay amount. Other points are similar to those in the first embodiment, and therefore will not be further described.

The configuration of a transmission system according to this embodiment is similar to that illustrated in FIG. 1, and therefore will not be further described. In this embodiment, among the internal configurations of the transmission device 100, the configuration of the cross-connect unit 204 differs from that of the first embodiment.

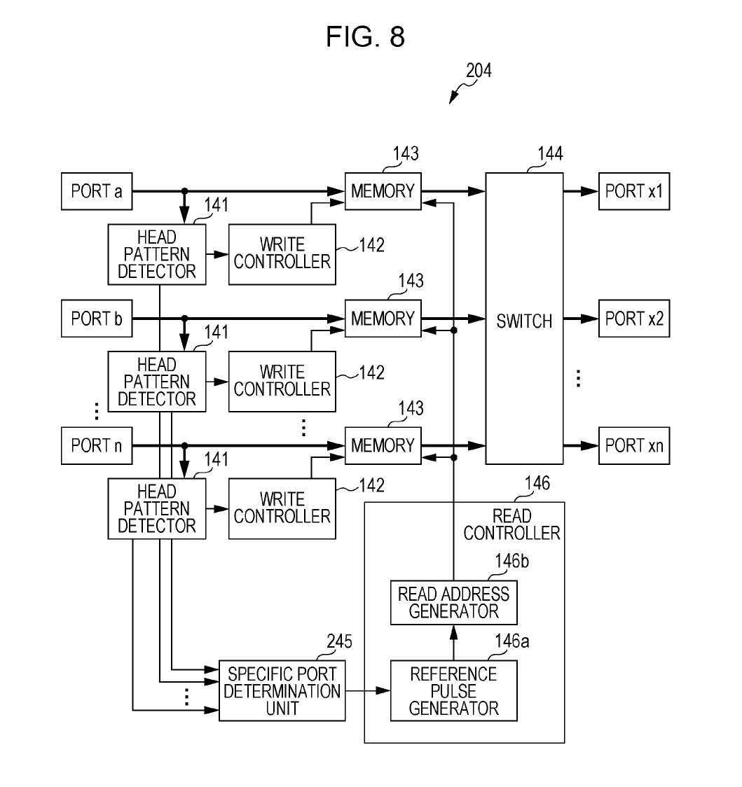

FIG. 8 is a block diagram illustrating a detailed configuration of a cross-connect unit in the second embodiment. In FIG. 8, the same portions as in FIG. 4 are denoted by the same reference numerals, and will not be further described. As illustrated in FIG. 8, the cross-connect unit 204 includes a specific port determination unit 245 instead of the specific port determination unit 145 illustrated in FIG. 4.

The specific port determination unit 245 measures a head position indicating the temporal position of a detection timing of an FAS detected by each head pattern detector 141, relative to a predetermined reference point of time, for each port. Then, the specific port determination unit 245 calculates a total sum of differences between the head position related to an arbitrary port, among the ports for which the head positions have been measured, and head positions related to ports other than the arbitrary port, as a total delay amount, and determines the port for which the calculated total delay amount is minimum, as a specific port.

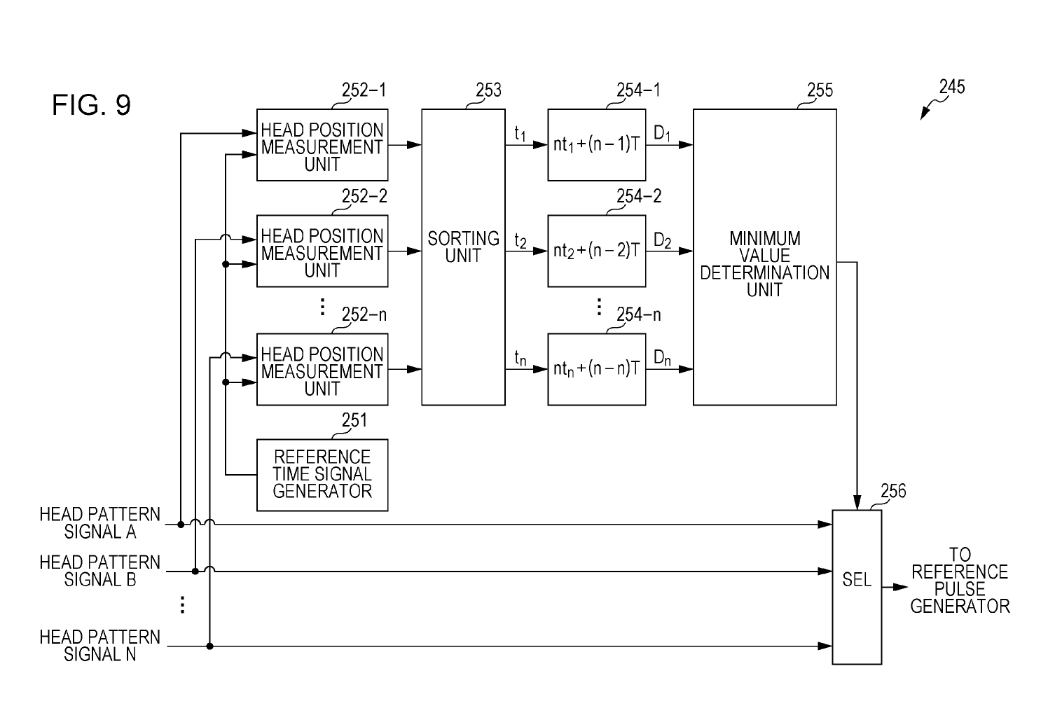

More particularly, as illustrated in FIG. 9, the specific port determination unit 245 includes a reference time signal generator 251, head position measurement units 252-1 to 252-n, a sorting unit 253, difference total-sum operation units 254-1 to 254-n, a minimum value determination unit 255, and a selector (SEL) 256. Note that FIG. 9 is a block diagram illustrating a configuration of the specific port determination unit in the second embodiment.

The reference time signal generator 251 generates a reference time signal, which is a signal containing a predetermined reference point of time, and outputs the generated reference time signal to the head position measurement units 252-1 to 252-n.

The head position measurement units 252-1 to 252-n receive the reference time signal from the reference time signal generator 251. The head position measurement units 252-1 to 252-n receive head pattern signals A, B, . . . , N from the head pattern detectors 141. The head position measurement units 252-1 to 252-n each determine a period of time elapsed from the reference point of time contained in the reference time signal to a timing at which an FAS is detected, on the basis of the reference point of time and the head pattern signals A, B, . . . , N, and measure the determined periods of elapsed time as head positions t₁ to tₙ for the respective ports. That is, the head positions t₁, t₂, . . . , tₙ are measured for the ports a, b, . . . , n. The head position measurement units 252-1 to 252-n output the head positions t₁ to tₙ measured for the respective ports to the sorting unit 253.

The sorting unit 253 receives the head positions t₁ to tₙ measured for the respective ports from the head position measurement units 252-1 to 252-n. The sorting unit 253 sorts the head positions t₁ to tₙ measured for the respective ports in ascending order, and outputs the head positions t₁ to tₙ sorted in ascending order to the difference total-sum operation units 254-1 to 254-n, respectively.

The difference total-sum operation units 254-1 to 254-n receive the head positions t₁ to tₙ sorted in ascending order from the sorting unit 253. In the case where a head position tⱼ related to an arbitrary port j (j=1, 2, . . . , n) is considered as a reference, the difference total-sum operation units 254-1 to 254-n calculate a total sum Dⱼ of differences between the head position tⱼ related to the port j and the head positions t₁ to tₙ (≠tⱼ) related to ports other than the port j. Here, j=1, 2, . . . , n are port identification numbers for identifying the ports a, b, . . . , n, respectively. The total sum of differences (hereinafter referred to simply as “difference total sum”) Dⱼ between the head position related to the port j and the head positions t₁ to tₙ (≠tⱼ) related to ports other than the port j is obtained using equation (1).

$${D}_{j} = {\sum }_{i = 1}^{j} ( {t}_{j} - {t}_{i} ) + {\sum }_{i = j + 1}^{n} ( {t}_{j} - ( {t}_{i} - T ) ) \qquad ( 1 )$$

wherein n is the number of all ports, and T is the frame period of data input from the port j.

Expanding the right-hand side of equation (1) yields equation (2).

$${D}_{j} = n {t}_{j} + ( n - j ) T - {\sum }_{i = 1}^{n} {t}_{i} \qquad ( 2 )$$

In equation (2), the term at the rightmost position is fixed without depending on j. Therefore, if this term is neglected, equation (2) may be expressed as equation (3).

Dⱼ=ntⱼ+(n−j) T (3)

In order to reduce the amount of operations, the difference total-sum operation units 254-1 to 254-n calculate the difference total sums Dⱼ expressed by equation (3) given above instead of the difference total sums Dⱼ expressed by equation (1) given above. The difference total-sum operation units 254-1 to 254-n output the calculated difference total sums Dⱼ to the minimum value determination unit 255.

The minimum value determination unit 255 receives the difference total sums Dⱼ from the difference total-sum operation units 254-1 to 254-n. The minimum value determination unit 255 determines a port related to a head pattern signal for which the difference total sum Dⱼ is minimum, as a specific port. The minimum value determination unit 255 outputs information on the specific port for which it has been determined that the difference total sum Dⱼ is minimum, to the selector 256.

The selector 256 receives the head pattern signals A, B, . . . , N from the head pattern detectors 141. The selector 256 receives information on the specific port for which it has been determined that the difference total sum Dⱼ is minimum, from the minimum value determination unit 255. Then, the selector 256 selects a head pattern signal related to the specific port for which it has been determined that the difference total sum Dⱼ is minimum, from the head pattern signals A, B, . . . , N, and outputs the selected head pattern signal to the reference pulse generator 146a of the read controller 146.

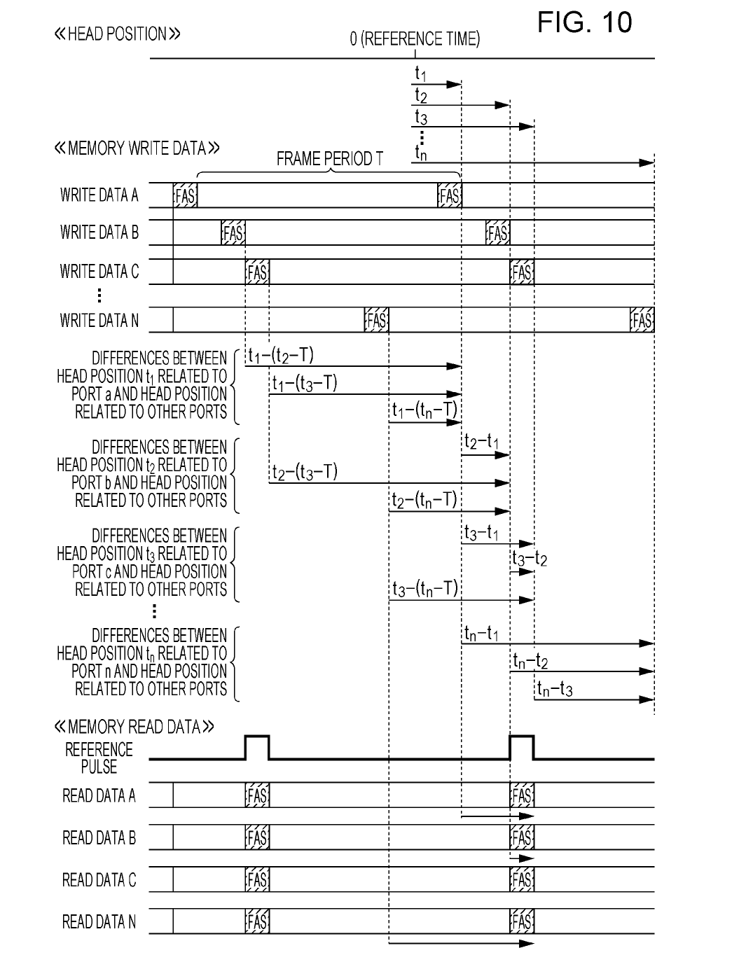

Next, a specific example of the synchronization control processing performed by the transmission device 100 of this embodiment is described. FIG. 10 is an explanatory diagram for explaining a specific example of synchronization control processing performed by a transmission device of the second embodiment. With reference to FIG. 10, an example where the transmission device 100 includes n ports a, b, c, . . . , n as ports that receive input of data, and writes the received data from the ports a, b, c, . . . , n, as write data A, B, C, . . . , N to memories, respectively, is now discussed. Additionally, it is assumed that j=1, 2, 3, . . . , n are port identification numbers for identifying the ports a, b, c, . . . , n, respectively.

The head pattern detectors 141 of the cross-connect unit 204 detect FASs, which are head patterns indicating the heads of write data A, B, C, . . . , N input from the ports a, b, c, . . . , n.

Subsequently, the write controllers 142 write the write data A, B, C, . . . , N to the memories 143 provided for the respective ports at detection timings of the detected FASs.

Subsequently, the specific port determination unit 245 receives the head pattern signals A, B, . . . , N from the head pattern detectors 141. Then, as illustrated in an upper part of FIG. 10, on the basis of the reference point of time and the head pattern signals A, B, . . . , N, the specific port determination unit 245 measures periods of time each elapsed from the reference point of time to the detection timing of an FAS, as the head positions t₁ to tₙ, for the respective ports. That is, the head positions t₁, t₂, tₙ are measured for the ports a, b, . . . , n. Then, the specific port determination unit 245 sorts the head positions t₁ to tₙ measured for the respective ports in ascending order.

Subsequently, in the case where the head position tₙ related to an arbitrary port j (j=1, 2, . . . , n) is considered as a reference, the specific port determination unit 245 calculates the difference total sum Dⱼ between the head position tⱼ related to the port j and head positions t₁ to tₙ (≠tⱼ) related to ports other than the port j.

For example, as illustrated in the center of FIG. 10, the specific port determination unit 245 calculates the total sum of differences t₁−(t₂−t₁−(t₃−T), . . . , t₁−(tₙ−T) between the head position t₁ related to the port a and the head positions related to ports other than the port a, as a difference total sum D₁. Note that, by substituting j=1 into equation (1) given above, the difference total sum D₁ is expressed using equation (4).

$${D}_{1} = ( {t}_{1} - {t}_{1} ) + {\sum }_{i = 2}^{n} ( {t}_{1} - ( {t}_{i} - T ) ) \qquad ( 4 )$$

Also as illustrated in the center of FIG. 10, the specific port determination unit 245 calculates the total sum of differences t₂−t₁, t₂−(t₃−T), . . . , t₂−T) between the head position t₂ related to the port b and the head positions related to ports other than the port b, as a difference total sum D₂. Note that, by substituting j=2 into equation (1) given above, the difference total sum D₂ is expressed using equation (5).

$${D}_{2} = ( {t}_{2} - {t}_{1} ) + ( {t}_{2} - {t}_{2} ) + {\sum }_{i = 3}^{n} ( {t}_{2} - ( {t}_{i} - T ) ) \qquad ( 5 )$$

Also as illustrated in the center of FIG. 10, the specific port determination unit 245 calculates the total sum of differences t₃−t₁, t₃−t₂, . . . , t₃−T) between the head position t₃ related to the port c and the head positions related to ports other than the port c, as a difference total sum D₃.

Note that, by substituting j=3 into equation (1) given above, the difference total sum D₃ is expressed using equation (6).

$${D}_{3} = ( {t}_{3} - {t}_{1} ) + ( {t}_{3} - {t}_{2} ) + ( {t}_{3} - {t}_{3} ) + {\sum }_{i = 4}^{n} ( {t}_{3} - ( {t}_{i} - T ) ) \qquad ( 6 )$$

Subsequently, the specific port determination unit 245 determines an arbitrary port j for which the difference total sum Dⱼ is minimum, as a specific port. Here, it is given that the difference total sum D₃ is minimum among the difference total sums Dⱼ. In this case, the specific port determination unit 245 determines the port c corresponding to the difference total sum D₃ as a specific port. Then, the specific port determination unit 245 outputs the head pattern signal C related to the port c, which is the specific port for which it has been determined that the difference total sum Dⱼ is minimum, to the reference pulse generator 146a of the read controller 146.

Subsequently, as illustrated in a lower part of FIG. 10, the read controller 146 generates a reference pulse in accordance with the detection timing of an FAS contained in the head pattern signal C related to the port c, which is the specific port for which it has been determined that the difference total sum Dⱼ is minimum.

Subsequently, the read controller 146 generates a read address in accordance with the reference pulse, and concurrently reads read data A, B, C, . . . , N from the memories 143 using the generated read address.

In this way, the transmission device 100 of this embodiment measures a head position indicating the temporal position of a detection timing of an FAS, relative to a predetermined reference point of time, for each port. Then, the transmission device 100 of this embodiment calculates total sums of differences each between the head position related to an arbitrary port, among the ports for which the head positions have been measured, and head positions related to ports other than the arbitrary port, as total delay amounts. Then, the transmission device 100 of this embodiment determines the port for which the calculated total delay amount is minimum, as a specific port. Then, the transmission device 100 of this embodiment reads data from all the memories 143 at the detection timing of an FAS related to the specific port for which it has been determined that the total delay amount is minimum. This enables the transmission device 100 to calculate the total delay amount among ports without using write addresses. As a result, with the transmission device 100 of this embodiment, the delay of data in a transmission device may be efficiently reduced.

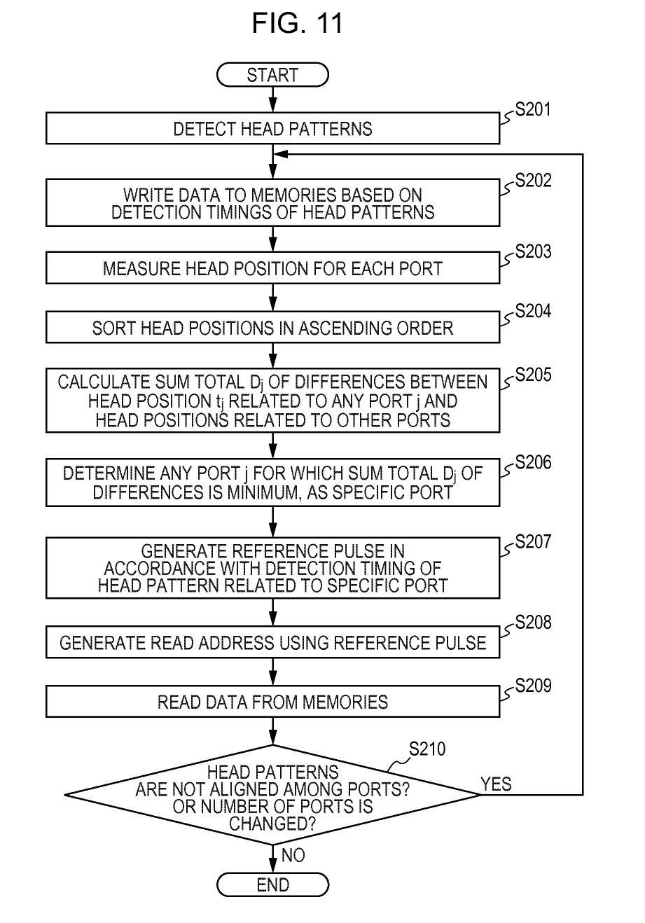

Next, the synchronization control processing performed by the transmission device 100 of this embodiment is described. FIG. 11 is a flowchart illustrating a processing procedure of the synchronization control processing performed by the transmission device of the second embodiment.

As illustrated in FIG. 11, the head pattern detectors 141 of the cross-connect unit 204 detect head patterns (FASs) indicating the heads of write data input from the ports (operation S201).

Subsequently, the write controllers 142 write data to the memories 143 at detection timings of FASs (operation S202). In particular, the write controllers 142 generate write addresses that increase with the periods of time elapsed from the detection timings of FASs detected by the head pattern detectors 141, for the respective ports, and write the generated write addresses to the memories 143 using the generated write addresses.

Subsequently, the specific port determination unit 245 measures a head position for each port (operation S203). Subsequently, the specific port determination unit 245 sorts measurement positions t₁ to tₙ measured for the respective ports in ascending order (operation S204).

Subsequently, the specific port determination unit 245 calculates a difference total sum Dⱼ between the head position tⱼ related to an arbitrary port j and the head positions related to other ports (operation S205). For example, the specific port determination unit 245 calculates a difference total sum Dⱼ using the mathematical expression given by equation (3) mentioned above.

Subsequently, the specific port determination unit 245 determines an arbitrary port j for which the calculated difference total sum Dⱼ is minimum, as a specific port (operation S206). Here, the difference total sum Dⱼ corresponds to the total delay amount, which is the total sum of delay amounts from the FAS related to the specific port to each of FASs related to ports other than the specific port.

Subsequently, the read controller 146 generates a reference pulse in accordance with the detection timing of an FAS related to the specific port for which it has been determined by the specific port determination unit 245 that the total delay amount is minimum (operation S207).

Subsequently, the read controller 146 generates a read address in accordance with the reference pulse (operation S208), and reads data from each memory 143 using the generated read address (operation S209). The data read from each memory 143 is input to the switch 144, and the switch 144 changes the transmission path of the data.

Thereafter, if the FASs detected by the head pattern detectors 141 are not aligned among ports, or if the number of ports that receive input of data is changed (affirmative in operation S210), the specific port determination unit 245 returns the process to operation S202. That is, if the FASs detected by the head pattern detectors 141 are not aligned among ports, or if the number of ports that receive input of data is changed, the specific port determination unit 245 redetermines a specific port for which the total delay amount is minimum.

If the FASs detected by the head pattern detectors 141 are aligned among ports, or if the number of ports that receive input of data is not changed (negative in operation S210), the specification port determination unit 245 completes the process.

As described above, the transmission device 100 of this embodiment measures a head position indicating the temporal position of a detection timing of an FAS, relative to a predetermined reference point of time, for each port. Then, the transmission device 100 of this embodiment calculates total sums of differences each between the head position related to an arbitrary port, among the ports for which the head positions have been measured, and head positions related to ports other than the arbitrary port, as total delay amounts. Then, the transmission device 100 of this embodiment determines the port for which the calculated total delay amount is minimum, as a specific port. Then, the transmission device 100 of this embodiment reads data from all the memories 143 at the detection timing of an FAS related to the specific port for which it has been determined that the total delay amount is minimum. This enables the transmission device 100 to calculate the total delay amount among ports without using write addresses. As a result, with the transmission device 100 of this embodiment, the delay of data in a transmission device may be efficiently reduced.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A transmission device comprising:
a detector configured to detect a head pattern indicating a head of data for each of ports that receives the data;
a write controller configured to write the data to a memory provided for each of the ports, based on a detection timing of the head pattern detected by the detector;
a determination unit configured to determine, among ports for each of which the head pattern has been detected by the detector, a specific port for which a total delay amount is minimum, the total delay amount being a total sum of delay amounts from the head pattern related to the specific port to each of the head patterns related to ports other than the specific port; and
a read controller configured to read the data from the memory, based on the detection timing of the head pattern related to the specific port determined by the determination unit.

2. The transmission device according to claim 1,
wherein the write controller generates, for each of the ports, an address that increases with a period of time elapsed from the detection timing of the head pattern detected by the detector, and writes the data to the memory using the generated address, and
wherein the determination unit acquires the generated address, calculates a total value of the generated addresses related to all ports, based on the detection timing, as the total delay amount for each of the ports, and determines the port for which the calculated total delay amount is minimum, as the specific port.

3. The transmission device according to claim 1, wherein the determination unit measures a head position indicating a temporal position of the detection timing of the head pattern detected by the detector, relative to a predetermined reference point of time, for each of the ports, calculates a total sum of differences between the head position related to an arbitrary port, among the ports for each of which the head position has been measured, and the head positions related to ports other than the arbitrary port, as the total delay amount, and determines the port for which the calculated total delay amount is minimum, as the specific port.

4. The transmission device according to claim 1, wherein if the head patterns detected by the detector are not aligned among the ports after the specific port for which the total delay amount is minimum is determined, the determination unit redetermines the specific port for which the total delay amount is minimum.

5. The transmission device according to claim 2, wherein if the head patterns detected by the detector are not aligned among the ports after the specific port for which the total delay amount is minimum is determined, the determination unit redetermines the specific port for which the total delay amount is minimum.

6. The transmission device according to claim 3, wherein if the head patterns detected by the detector are not aligned among the ports after the specific port for which the total delay amount is minimum is determined, the determination unit redetermines the specific port for which the total delay amount is minimum.

7. The transmission device according to claim 1, wherein if the number of ports that receive the data is changed after the specific port for which the total delay amount is minimum is determined, the determination unit redetermines the specific port for which the total delay amount is minimum.

8. The transmission device according to claim 2, wherein if the number of ports that receive the data is changed after the specific port for which the total delay amount is minimum is determined, the determination unit redetermines the specific port for which the total delay amount is minimum.

9. The transmission device according to claim 3, wherein if the number of ports that receive the data is changed after the specific port for which the total delay amount is minimum is determined, the determination unit redetermines the specific port for which the total delay amount is minimum.

10. A synchronization control method comprising:
detecting a head pattern indicating a head of data for each of ports that receives the data;
writing the data to a memory provided for each of the ports, based on a detection timing of the detected head pattern;
determining, among ports for each of which the head pattern has been detected, a specific port for which a total delay amount is minimum, the total delay amount being a total sum of delay amounts from the head pattern related to the specific port to each of the head patterns related to ports other than the specific port; and
reading the data from the memory, based on the detection timing of the head pattern related to the specific port for which it has been determined that the total delay amount is minimum.
